(19) United States
(12) Patent Application Publication
(10) Pub. No.: US 2016/0083098 A1
(43) Pub. Date: Mar. 24, 2016

(54) AIRCRAFT AND SEAT TRACK ASSEMBLIES FOR VIBRATION ISOLATION OF FLOOR MOUNTED COMPONENTS

(71) Applicant: Gulfstream Aerospace Corporation, Savannah, GA (US)

(72) Inventors: Michael Lucas, Savannah, GA (US); Kristopher P. Lynch, Savannah, GA (US); Benjamin Frank Wilson, Savannah, GA (US); Jeffrey Jonas, Savannah, GA (US)

(21) Appl. No.: 14/495,667

(22) Filed: Sep. 24, 2014

(51) Int. Cl. B64D 11/06

(52) U.S. Cl. CPC B64D 11/0696; B64D 11/06

(57) ABSTRACT

Aircraft, vibration isolation assemblies, and methods of assembling vibration isolation assemblies are provided. An aircraft includes a fuselage, a mounted component disposed within the fuselage, and a vibration isolation assembly disposed within the fuselage and mounting the mounted component to the fuselage. The vibration isolation assembly includes a mounting track, an inner member, a support fitting, and an elastomer. The mounting track defines a cavity and an opening. The inner member has a post and a flange, where the flange is disposed in the cavity. The support fitting is secured to the post and the mounted component. The elastomer is disposed between the flange and the mounting track within the cavity.

### TECHNICAL FIELD

The technical field relates generally to aircraft and seat track assemblies for vibration isolation of floor mounted components, and more particularly relates to aircraft and seat track assemblies with elastomer encapsulated inner members disposed in a seat track cavity.

### BACKGROUND

A conventional passenger aircraft includes a fuselage, a cabin interior attached to and/or supported by the fuselage, and a floor that defines a bottom of the cabin interior and is supported by the fuselage. As the aircraft is flown, the fuselage interacts with the atmosphere. This interaction generates vibration that travels through the floor to any components secured to the floor. The vibrating components, if left unchecked, will be perceived by occupants of the aircraft as noise, which is undesirable.

The noise generated by these vibrating components may be reduced by using a vibration isolation assembly. One conventional vibration isolation assembly rigidly mounts a support fitting to the floor, and then fastens the mounted component to the support fitting using a vibration isolator. These conventional assemblies have spatial constraints that limit the size of the vibration assemblies. Such limited size can limit the noise reduction potential of these conventional assemblies. Although these conventional vibration isolation assemblies are suitable for their intended purpose, there is room for improvement.

As such, it is desirable to provide improved aircraft and assemblies for vibration isolation of floor mounted components. In addition, other desirable features and characteristics will become apparent from the subsequent summary and detailed description, and the appended claims, taken in conjunction with the accompanying drawings and this background.

### SUMMARY OF EMBODIMENTS

Various non-limiting embodiments of aircraft, vibration isolation assemblies, and methods of assembling vibration isolation assemblies are disclosed herein.

In a first non-limiting embodiment, an aircraft includes, but is not limited to, a fuselage, a mounted component disposed within the fuselage, and a vibration isolation assembly disposed within the fuselage and mounting the mounted component to the fuselage. The vibration isolation assembly includes a mounting track, an inner member, a support fitting, and an elastomer. The mounting track defines a cavity and an opening. The inner member has a post and a flange, where the flange is disposed in the cavity. The support fitting is secured to the post and the mounted component. The elastomer is disposed between the flange and the mounting track within the cavity.

In a second non-limiting embodiment, a vibration isolation assembly for an aircraft includes, but is not limited to, a seat track, an inner member, and an elastomer. The seat track defines a cavity and an opening. The inner member has a post and a flange, where the flange is disposed in the cavity and the post is configured to secure a mounted component. The elastomer is disposed within the cavity between the flange and the seat track.

In a third non-limiting embodiment, a method of assembling a vibration isolation assembly in an aircraft includes, but is not limited to, providing a seat track that defines a cavity and has an opening. The method further includes inserting a flange of an inner member and an elastomer into the cavity with a post of the inner member extending at least partially through the opening. The method still further includes fastening a support fitting to the post of the inner member. The method still further includes fastening a floor mounted component to the support fitting.

### BRIEF DESCRIPTION OF THE DRAWINGS

Advantages of the present invention will be readily appreciated, as the same becomes better understood by reference to the following detailed description when considered in connection with the accompanying drawings wherein:

FIG. 1 is a cross section view illustrating a non-limiting embodiment of an aircraft with a vibration isolation assembly in accordance with teachings of the present disclosure;

FIG. 2 is a cross section view illustrating a non-limiting embodiment of the vibration isolation assembly used in the aircraft of FIG. 1 in accordance with teachings of the present disclosure;

FIG. 3 is a cross section view of the vibration isolation assembly of FIG. 2 taken across the line 3-3; and

FIG. 4 is a flow diagram of a method of assembling a vibration isolation assembly in accordance with teachings of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various non-limiting embodiments of aircraft, vibration isolation assemblies, and methods of assembling vibration isolation assemblies are disclosed herein. The embodiments include various configurations of an elastomer encapsulated inner member disposed within a cavity of a seat track in an aircraft. By utilizing the cavity in the seat track, the size of the elastomer and inner member interacting with the elastomer may be increased when compared with conventional vibration isolation assemblies with elastomeric material inside a compartment of an aircraft. The larger size permits greater vibration attenuation and less noise in the compartment of the aircraft. Additionally, the embodiments disclosed herein are able to attenuate the vibrations with a larger volume of elastomer to improve noise isolation performance over conventional assemblies. A greater understanding of the aircraft and vibration isolation assemblies may be obtained through a review of the illustrations accompanying this application together with a review of the detailed description that follows.

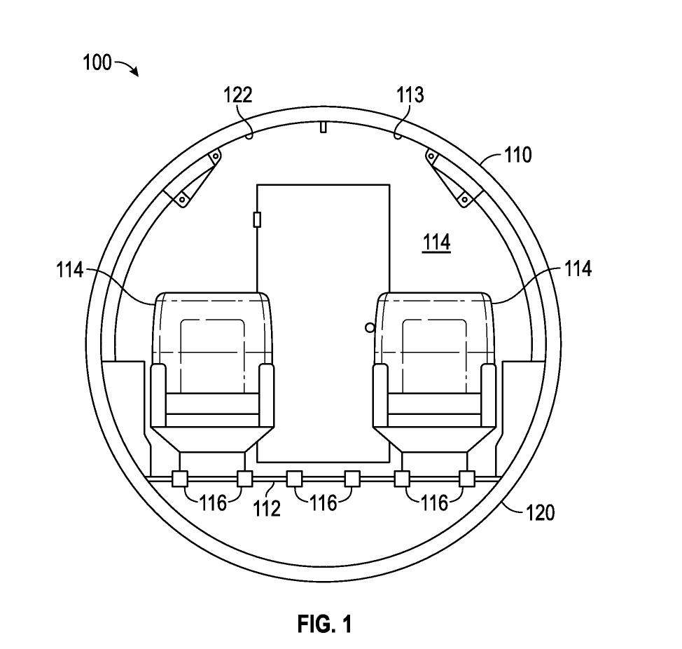

Referring now to FIG. 1, an aircraft 100 is illustrated in a cross-sectional view in accordance with the teachings of the present disclosure. Aircraft 100 includes a fuselage 110, a floor 112, a compartment 113, floor mounted components 114, and a vibration isolation assembly 116 for each of the floor mounted components 114. In the example provided, aircraft 100 is a jet airplane. In other embodiments, aircraft 100 may be any other type of airborne vehicle, including, but not limited to, helicopters, propeller operated planes, or air ships without departing from the scope of the present disclosure.

Fuselage 110 includes an outer skin 120 and a frame structure 122 to which outer skin 120 is secured. Floor 112 includes a plurality of cross braces, a plurality of floor panels, and a plurality of seat tracks or mounting tracks that are also included in vibration isolation assembly 116. The arrangement of the cross braces, floor panels, and mounting tracks may have any suitable configuration based on the particular implementation, as will be appreciated by those with ordinary skill in the art. In general, floor 112 is secured to fuselage 110. Compartment 113 is a cabin, cockpit, or other area enclosed by floor 112 and fuselage 110.

Floor mounted components 114 include any components that are mounted to floor 112 by vibration isolation assembly 116. In the example provided, two passenger seats and a bulkhead are illustrated as floor mounted components 114. It should be appreciated that other components, such as cabinets, divans or couches, tables, drawers, or other floor mounted components may be mounted to floor 112 with the vibration isolation assembly 116.

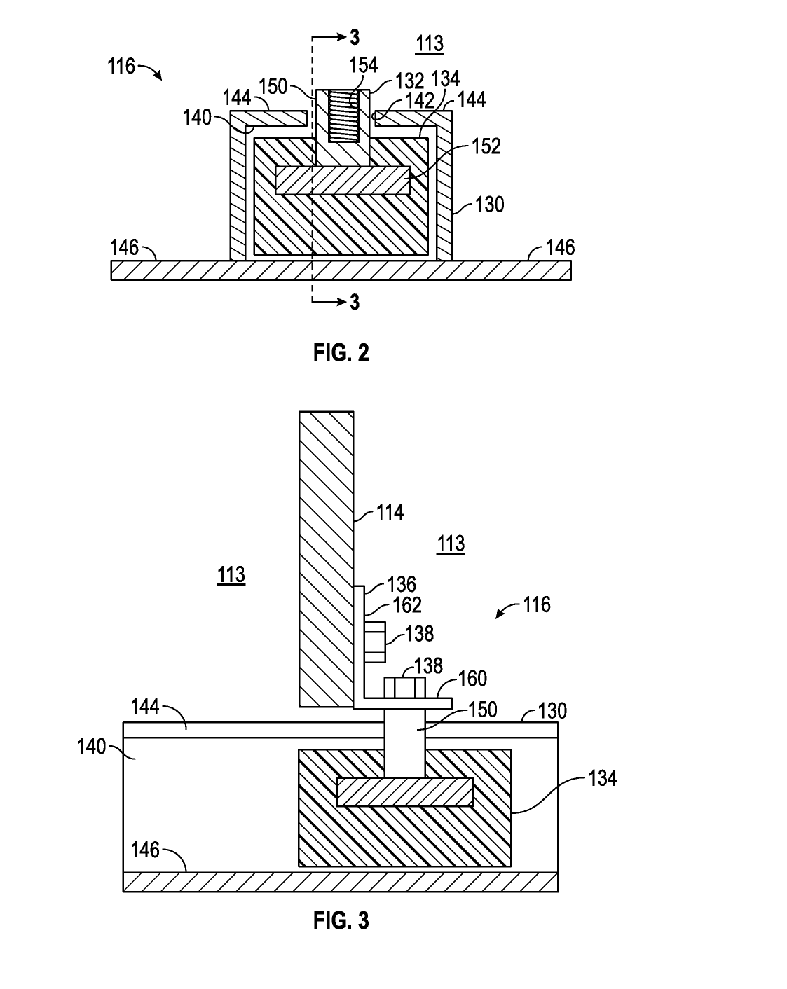

Referring now to FIG. 2 and FIG. 3, vibration isolation assembly 116 is illustrated in greater detail. FIG. 2 illustrates a cross sectional view of a vibration isolation assembly 116 before a floor mounted component 114 has been mounted to it, and FIG. 3 illustrates a bulkhead mounted to vibration isolation assembly 116. Vibration isolation assembly 116 includes a seat track 130, an inner member 132, an elastomer 134, a support fitting 136, and fasteners 138.

Seat track 130 is secured to fuselage 110 and is typically oriented to extend along a longitudinal direction of fuselage 110. In some embodiments, seat track 130 may be oriented in other directions, such as a lateral direction of fuselage 110. As used herein, the term “seat track” refers to a track configured to be secured to the floor structure of a vehicle, such as aircraft 100, and to which components are mounted. It should be appreciated that the components mounted to seat track 130 are not limited to seats. Seat track 130 is a type of mounting track. As used herein, the term “mounting track” refers to a track that is configured to mount components to the vehicle, but may be configured to be secured to any portion of the vehicle and may be oriented in any direction. In the example provided, four longitudinally oriented seat tracks 130 are spaced laterally within floor 112. It should be appreciated that any suitable number of seat tracks 130 may be utilized without departing from the scope of the present disclosure.

Seat track 130 is formed from a rigid material that defines a cavity 140 and an opening 142 that faces a ceiling of aircraft 100 when installed in fuselage 110, as illustrated in FIG. 1. In the example provided, seat track 130 is an extruded aluminum track with a substantially c-channel shaped cross section that opens toward the ceiling of aircraft 100 in the installed position illustrated in FIG. 1. The width of opening 142 is less than a width of cavity 140 to form first flange portions 144. Second flange portions 146 extend laterally outward from a bottom of seat track 130. Second flange portions 146 improve stiffness of seat track 130 in the longitudinal direction and provide a surface to which floor boards and cross members of floor 112 may be secured.

Seat track 130 may be secured within floor 112 by any suitable fasteners or connectors. For example, seat track 130 may be bolted or riveted to lateral cross members of floor 112 and may support floor boards of floor 112. Seat track 130 is secured to fuselage 110 through such cross members, and may be additionally secured to fuselage 110 at each longitudinal end of seat track 130.

Inner member 132 is formed from a rigid material and has a post 150 and a flange 152. The rigid material of inner member 132 may be any suitable material, including, but not limited to, aluminum, steel, and other metals or stiff plastics. Flange 152 is disposed within cavity 140 and has a cross-sectional width that is larger than the cross-sectional width of opening 142 in the lateral direction of fuselage 110. Accordingly, flange 152 engages with first flange portions 144 of seat track 130 to retain flange 152 within inner cavity 140.

Post 150 is configured to secure mounted components 114 by use of a threaded bore 154. Threaded bore 154 is configured to mate with threads of fasteners 138. It should be appreciated that post 150 may be configured to secure mounted components with other fasteners or arrangements. Post 150 is partially disposed in and extends through opening 142 of seat track 130. It should be appreciated that post 150 may have shorter lengths that do not extend through opening 142, and may utilize other suitable fastener configurations without departing from the scope of the present disclosure.

Elastomer 134 is disposed in cavity 140 between flange 152 and seat track 130 to attenuate vibrations traveling from seat track 130 to inner member 132. Such attenuation reduces the vibration of support fitting 136 and mounted component 114 to reduce noise perceived by passengers of aircraft 100. In the example provided, elastomer 134 encapsulates flange 152 and fills substantially the entire cross-sectional area of cavity 140 not occupied by inner member 132. A length of flange 152 and elastomer 134 along the longitudinal direction of seat track 130 may be selected according to the particular implementation. Because cavity 140 is within seat track 130, the length of flange 152 and elastomer 134 are not limited by available space within compartment 113 or by aesthetics. Accordingly, a larger flange 152 and elastomer may be implemented when compared with prior vibration isolation assemblies.

Support fitting 136 is formed from a metal or other rigid material for securing mounted components 114 to inner member 132. In the example provided, support fitting 136 is an L-shaped aluminum piece with a horizontal portion 160 and a vertical portion 162. In some embodiments, support fitting 136 has other shapes and is formed from other materials. Support fitting 136 is secured to inner member 132 with fastener 138 when fastener 138 threads into threaded bore 154.

Support fitting 136 also abuts and directly secures to mounted component 114 by a second fastener 138. Because support fitting 136 is isolated from vibration of seat track 130, no additional elastomeric material is required between support fitting 136 and mounted component 114. Accordingly, vibration isolation assembly 116 requires less space in compartment 113 and reduces noise generated by support fittings when compared with conventional vibration isolation assemblies.

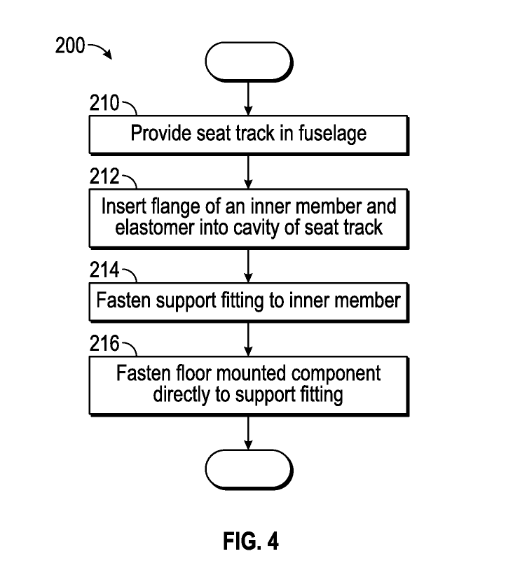

Referring now to FIG. 4, and with continuing reference to FIGS. 1-3, a non-limiting embodiment of a method 200 of assembling a vibration isolation assembly is illustrated. At step 210, a seat track is obtained and installed in the fuselage of an aircraft. Any suitable seat track may be employed and may be installed in any suitable fuselage of any suitable aircraft. In one example, seat track 130 may be obtained and installed in fuselage 110 of aircraft 100.

In operation 212, an inner member is inserted into a cavity of the seat track. For example, flange 152 of inner member 132 and elastomer 134 may be inserted into cavity 140 of seat track 130. In operation 214, a support fitting is fastened to the inner member. For example, support fitting 136 may be fastened directly to inner member 132 with fastener 138. In operation 216, a floor mounted component is fastened directly to the support fitting. For example, floor mounted component 114 may be fastened directly to support fitting 136 with another fastener 138.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft comprising:
a fuselage;
a mounted component disposed within the fuselage; and
a vibration isolation assembly disposed within the fuselage and mounting the mounted component to the fuselage, the vibration isolation assembly comprising:
a mounting track defining a cavity and an opening,
an inner member having a post and a flange, wherein the flange is disposed in the cavity,
a support fitting secured to the post and the mounted component, and
an elastomer disposed between the flange and the mounting track within the cavity.

2. The aircraft of claim 1, wherein the post is at least partially disposed in the opening.

3. The aircraft of claim 1, wherein the mounting track has a substantially c-channel shaped cross section.

4. The aircraft of claim 1, wherein the support fitting is mounted directly to the post of the inner member.

5. The aircraft of claim 1, wherein the mounted component abuts and is directly fastened to the support fitting.

6. The aircraft of claim 1, wherein the elastomer encapsulates at least a portion of the inner member.

7. The aircraft of claim 6, wherein the elastomer fills substantially an entire longitudinal cross-section of the cavity.

8. The aircraft of claim 1, wherein the flange has a first cross sectional width that is larger than a second cross sectional width of the opening to retain the flange in the cavity.

9. A vibration isolation assembly for an aircraft, the vibration isolation assembly comprising:
a seat track defining a cavity and an opening;
an inner member having a post and a flange, wherein the flange is disposed in the cavity and the post is configured to secure a mounted component; and
an elastomer disposed within the cavity between the flange and the seat track.

10. The vibration isolation assembly of claim 9, wherein the post is at least partially disposed in the opening.

11. The vibration isolation assembly of claim 9, wherein the seat track has a substantially c-channel shaped cross section.

12. The vibration isolation assembly of claim 9, further comprising a support fitting mounted directly to the inner member.

13. The vibration isolation assembly of claim 12, further comprising the mounted component directly connected to and abutting the support fitting.

14. The vibration isolation assembly of claim 9, wherein the elastomer encapsulates at least a portion of the inner member.

15. The vibration isolation assembly of claim 14, wherein the elastomer fills substantially an entire longitudinal cross section of the cavity.

16. The vibration isolation assembly of claim 9, wherein the flange has a first cross sectional width that is larger than a second cross sectional width of the opening to retain the flange in the cavity.

17. The vibration isolation assembly of claim 9, wherein the seat track is configured to be secured to a fuselage of the aircraft.

18. A method of assembling a vibration isolation assembly in an aircraft, the method comprising:
providing a seat track that defines a cavity and has an opening;
inserting a flange of an inner member and an elastomer into the cavity with a post of the inner member extending at least partially through the opening;
fastening a support fitting to the post of the inner member; and
fastening a floor mounted component to the support fitting.

19. The method of claim 18, wherein fastening the floor mounted component to the support fitting includes fastening the floor mounted component directly to the support fitting so that the floor mounted component abuts the support fitting.

20. The method of claim 18, wherein inserting the flange and the elastomer includes filling substantially an entire longitudinal cross sectional area of the cavity with the flange and the elastomer.
